(19) United States
(12) Patent Application Publication
(10) Pub. No.: US 2002/0081239 A1
(43) Pub. Date: Jun. 27, 2002

(54) Device for exhaust gas after treatment of diesel engines

(75) Inventors: Edwin Palesch, Lenningen (DE); Dieter Maisch, Kohlberg (DE); Stefan Klotz, Aichtal (DE)

Correspondence Address: Gudrun E. Huckett, Ph.D., P.O. Box 3187, Albuquerque, NM, 87190-3187, US

(73) Assignee: Hydraulik-Ring GmbH, Limbach- Oberfrohna (DE)

(21) Appl. No.: 10/084,862

(22) Filed: Oct. 19, 2001

(30) Foreign Application Priority Data
Oct. 19, 2000 (DE) 10052077.4

(51) Int. Cl. B01D 53/34; F01N 3/00

(52) U.S. Cl. 422/168; 422/172; 422/224

(57) ABSTRACT

A device for exhaust gas after treatment of diesel engines has one or more storage containers containing an urea solution and having a flexible wall. At least one compressed air conduit is connected to a mixing area and supplies compressed air to the mixing area. A pump conveys the urea solution from the storage container to the mixing area where a mist of the urea solution and the compressed air is formed. In another embodiment, the pump is eliminated and the urea solution is conveyed under its own weight from the storage container to the mixing area. In yet another embodiment, a pressure chamber is provided in which the storage container is arranged. A compressed air supply conduit is connected to the pressure chamber and pressurizes the exterior of the storage container.

### BACKGROUND OF THE INVENTION

1. Field of the Invention

The invention relates to a device for exhaust gas after treatment of diesel engines, wherein the device comprises at least one storage container for an urea solution which is supplied by means of a pump to a mixing area into which at least one compressed air conduit opens.

2. Description of the Related Art

For the exhaust gas after treatment of diesel engines selective catalytic reduction (SCR) catalytic converters are used. These catalytic converters employ NH₃ as a reducing agent for reducing NOₓ. NH₃ is generated by hydrolysis or thermolysis of a 32.5 % urea solution in a metering block and, mixed with air, injected into the exhaust gas upstream of the catalytic converter. The urea solution must be supplied at a certain pressure to the metering block. The urea solution is contained in a storage container and is supplied by means of a pump from the storage container into the mixing area. Compressed air is also supplied to the mixing area. Within the mixing area mixing of compressed air and the urea solution takes place. In this way, a mist is formed which is supplied to the catalytic converter. A problem is the re-filling of urea solution into the storage container because corresponding refill stations are not yet available and must still be implemented.

### SUMMARY OF THE INVENTION

It is an object of the present invention to configure the device according to the aforementioned kind such that a problem-free supply with urea solution is ensured. In this context, the urea solution is to be supplied in a simple way to the mixing area.

In accordance with the present invention, this is achieved according to a first embodiment in that the storage container has a flexible wall. This refill container can be transported easily within the motor vehicle, in particular, a truck, and can be introduced, when needed, into the device according to the invention. The flexible refill container can be folded to a very small size after the urea solution has been consumed so that they require only little space for their disposal. Accordingly, the disposal of the empty refill containers is possible without problems.

In a second embodiment of the invention, the urea solution is supplied from the storage container via at least one urea conveying conduit to the mixing area and is conveyed from the storage container into the urea conveying conduit by its own weight. Accordingly, the urea solution is conveyed from the storage container into the mixing area without requiring a pump. Instead, the urea solution flows under its own weight into the urea conveying conduit from where it then flows into the mixing area. Since the pump is no longer needed, the device according to the invention has a constructively simple configuration. Moreover, it can be produced inexpensively.

According to another embodiment of the invention, the urea solution is supplied from the storage container via at least one urea conveying conduit to the mixing area and the storage container is arranged in a pressure chamber into which at least one compressed air supply conduit opens. Accordingly, the storage container is provided in a pressure chamber and compressed air is supplied into the pressure chamber via a compressed air conduit. The storage container is thus additionally pressurized from the exterior so that the urea solution flows also by pressure loading into the urea conveying conduit. This ensures that the urea solution flows reliably into the urea conveying conduit.

In another embodiment according to the invention, the urea solution is supplied from the storage container via at least one urea conveying conduit to the mixing area and the wall of the storage container is formed at least partially by a flexible pressure membrane. The flexible pressure membrane is elastically deformed by applying an external pressure so that the urea solution contained within the storage container is reliably supplied into the urea conveying conduit.

### BRIEF DESCRIPTION OF THE DRAWING

In the drawing:

FIG. 1 is a first embodiment of a device for exhaust gas after treatment of the diesel engine;

FIG. 2 is a second embodiment of a device for exhaust gas after treatment of the diesel engine;

FIG. 3 is a third embodiment of a device for exhaust gas after treatment of the diesel engine;

FIG. 4 is a fourth embodiment of a device for exhaust gas after treatment of the diesel engine;

FIG. 5 is a fifth embodiment of a device for exhaust gas after treatment of the diesel engine;

FIG. 6 is a sixth embodiment of a device for exhaust gas after treatment of the diesel engine;

FIG. 7 is a seventh embodiment of a device for exhaust gas after treatment of the diesel engine;

FIG. 8 is an eighth embodiment of a device for exhaust gas after treatment of the diesel engine;

FIG. 9 is a ninth embodiment of a device for exhaust gas after treatment of the diesel engine;

FIG. 10 is a tenth embodiment of a device for exhaust gas after treatment of the diesel engine;

FIG. 11 is an eleventh embodiment of a device for exhaust gas after treatment of the diesel engine;

FIG. 12 is a twelfth embodiment of a device for exhaust gas after treatment of the diesel engine;

FIG. 13 is a thirteenth embodiment of a device for exhaust gas aftertreatment of the diesel engine;

FIG. 14 is a fourteenth embodiment of a device for exhaust gas after treatment of the diesel engine.

### DESCRIPTION OF THE PREFERRED EMBODIMENTS

So-called SCR (selective catalytic reduction) catalytic converters are used for the exhaust gas after treatment of diesel engines. In this method, NH₃ is used as a reducing agent for reducing NOₓ. NH₃ is generated by hydrolysis orthermolysis of a 32.5% urea solution in a metering block and, mixed with air, injected into the exhaust gas upstream of the SCR catalytic converter. The urea solution is supplied at a certain pressure to the metering block.

In the embodiment according to FIG. 1, the urea solution is contained in a flexible container 1 which is provided with a connector 2 with which the storage container 1 can be connected to a pump line 3. By means of a pump 4 the urea solution is supplied to the mixing chamber (not illustrated) arranged downstream. The connector 2 of the container 1 is provided within a container closure 5 and can be formed, for example, by an opening within the closure 5 which is initially closed off by a foil or a different type of closure piece. The container closure 5 is of a thick configuration so that it can be easily pushed onto the pump line 3. The closure 5 can be configured such that upon placing the container 1 onto the pump line 3, it is penetrated by the pump line 3. The cross-section of the opening within the closure 5 is matched to the outer diameter of the pump line 3 so that urea solution cannot penetrate through the opening to the exterior after the container 1 has been placed onto the pump line 3.

By means of the pump 4 the urea solution is pumped out of the flexible container 1 and supplied to the mixing chamber. An air supply conduit opens into this mixing chamber via which air can be supplied in the required amount under pressure to the urea solution. In the mixing chamber the urea solution and the compressed air are intensively mixed so that a mist results which is supplied to the catalytic converter.

The container 1 is comprised advantageously of a flexible plastic material. When pumping the urea solution out of the container 1, the flexible container 1, as a result of the vacuum generated therein, will contract so that the empty container 1 is advantageously deflated. The empty container 1 requires thus only a minimal space for its disposal. The flexible container 1 can be carried onboard the vehicle and can be exchanged as needed. Moreover, such a container 1 can be manufactured inexpensively.

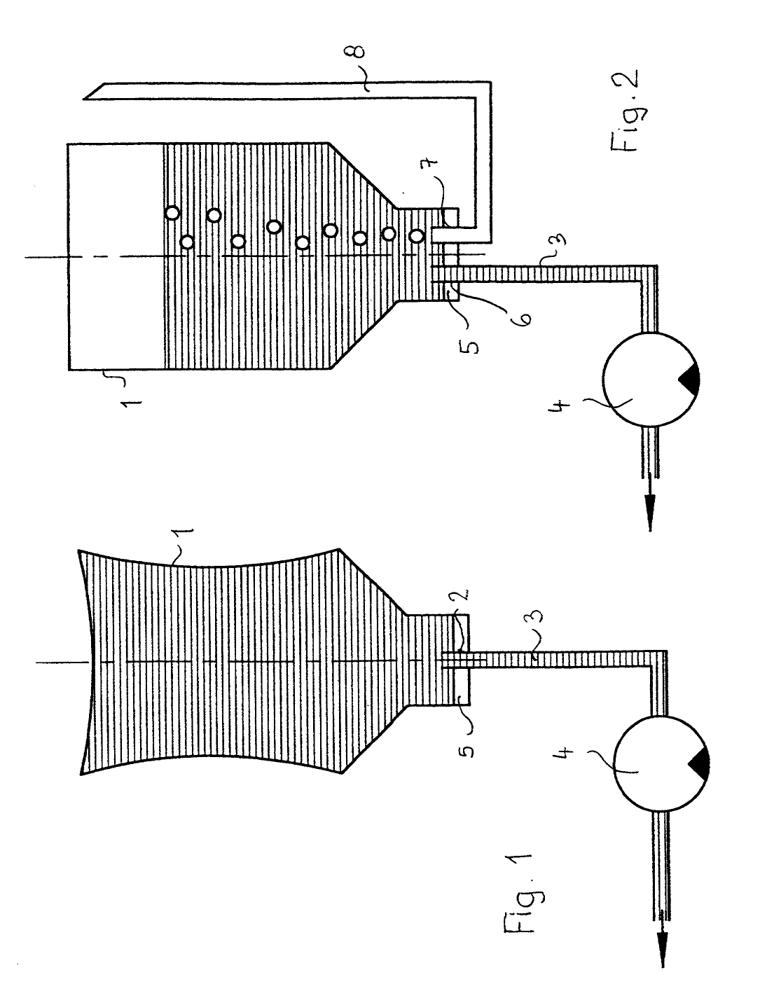

In the embodiment according to FIG. 2, the container 1 is shape-stable and in the form of a stable cartridge. The closure 5 of this container 1 has a passage 6 for the pump line 3 and a passage 7 for an air supply conduit 8. By means of the pump 4, the urea solution contained in the container 1 is pumped out in the described way and supplied to the mixing chamber (not illustrated) in which the urea solution is mixed with compressed air to form a fine mist. In the amount in which the urea solution is removed from the container 1, air is guided into the container 1 via the air supply conduit 8. The supply of air via the air supply conduit 8 is possible without problems (atmospheric pressure). In trucks having a compressed air system the container can even be pressurized. The container 1 can also be easily carried onboard the vehicle and can be exchanged as needed.

By using the containers 1 according to FIGS. 1 and 2, the logistic problems in regard to the supply of the device with the required urea solution is solved in a simple way.

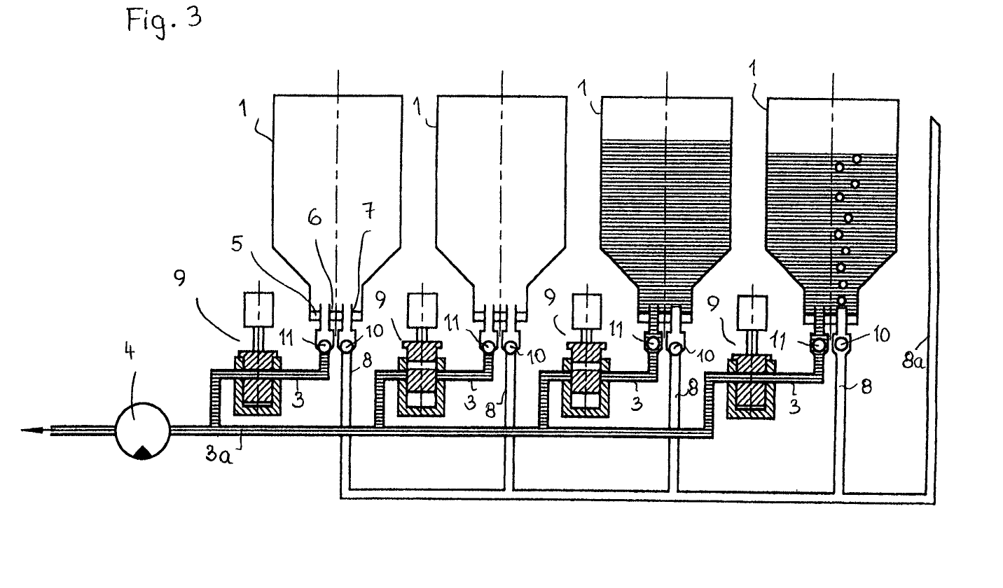

FIG. 3 shows a device having several containers 1 arranged adjacent to one another and connected together to the pump 4. The containers 1 are configured according to the embodiment of FIG. 2. The closure 5 is provided respectively with the two passages 6, 7 for the pump line 3 and the air supply conduit 8. The individual pump lines 3 are connected to a common pump main 3a in which the pump 4 is positioned. Each of the pump lines 3 has an on-off valve 9 with which the pump lines 3 can be opened and closed independent from one another. The individual air supply conduits 8 also open into a common air supply main 8a. A float valve 10 is arranged in the air supply conduits 8, respectively, in the flow direction of the air upstream of the passages 7 communicating with the storage containers 1. Moreover, in the pump lines 3 a float valve 11 is positioned downstream of the passages 6 into the container 1 in the flow direction of the urea solution.

In the illustrated embodiment, the on-off valves 9 of the right and left containers 1 are adjusted such that the pump lines 3 are connected to the common pump main 3a. The on-off valves 9 of the two centrally arranged containers 1 are in the closed position so that the pump lines 3 are closed. The left container 1 in FIG. 3 is completely empty while the right container is still mostly filled. The left container of the centrally arranged containers is completely empty while the right container still contains urea solution. The pump 4 pumps the urea solution from the right and left containers 1 in FIG. 3 whose on-off valves 9 are open. Via the air supply conduits 8 air is filled into the container in an amount or volume matching the amount of urea solution that has been removed. As soon as one of the containers 1 is empty, it is separated from the pump line 3 by switching the on-off valve 9 and can then be exchanged without problems.

The containers 1 can be shape-stable containers according to the embodiment of FIG. 2 or flexible containers according to the embodiment of FIG. 1.

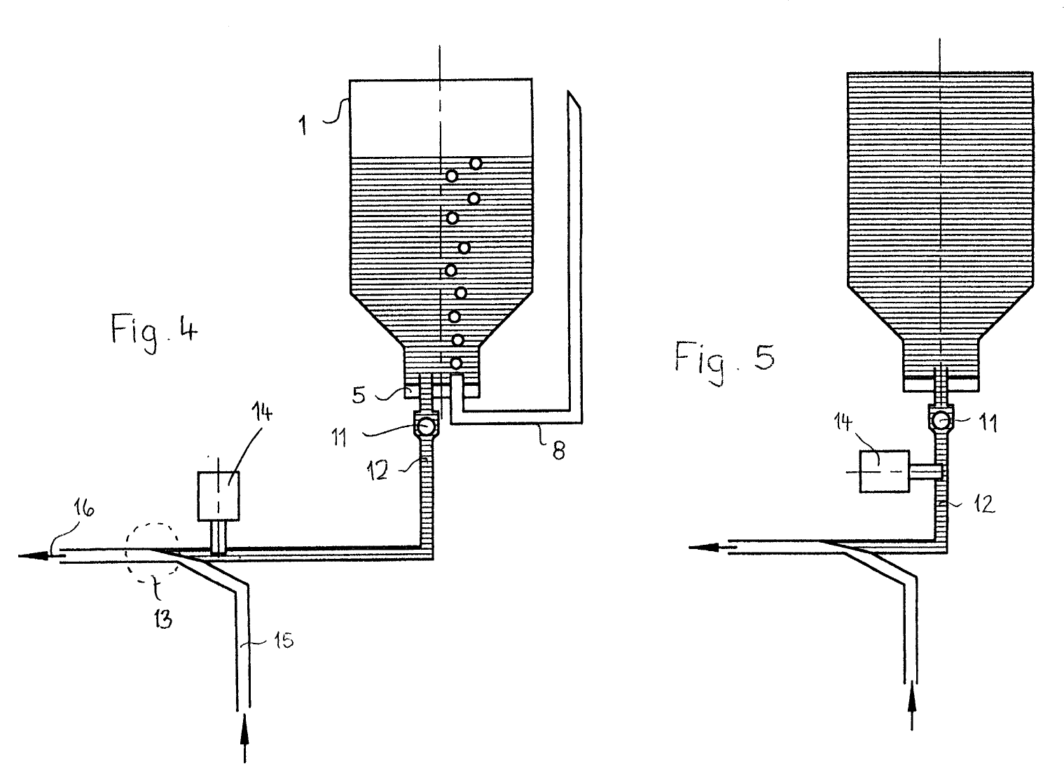

FIG. 4 shows an embodiment in which the urea solution can be supplied to the mixing chamber (not illustrated) without a pump. The container 1 is placed with its closure 5 onto the air supply conduit 8 and an urea conveying conduit 12. Air at atmospheric pressure is introduced into the container 1 via the conduit 8. The air in the container 1 prevents the generation of a vacuum and ensures that the urea solution can be supplied reliably via the urea conveying conduit 12 into the mixing area 13. In the urea conveying conduit 12, in accordance with the embodiment of FIG. 3, a float valve 11 is arranged which is in the open position according to FIG. 4 as long as urea solution flows from the container 1 through the urea conveying conduit 12. In the flow direction upstream of the mixing area 13 a metering device 14 is arranged in the urea conveying conduit 12 with which the flow volume of the urea solution can be adjusted.

A compressed air conduit 15 opens into the mixing area 13 and the compressed air is mixed with the supplied urea solution in the way described above. The resulting mist is then supplied in the flow direction 16 to the catalytic converter.

The container 1 is arranged within the vehicle such that the urea solution flows into urea conveying conduit 12 until the container 1 is empty.

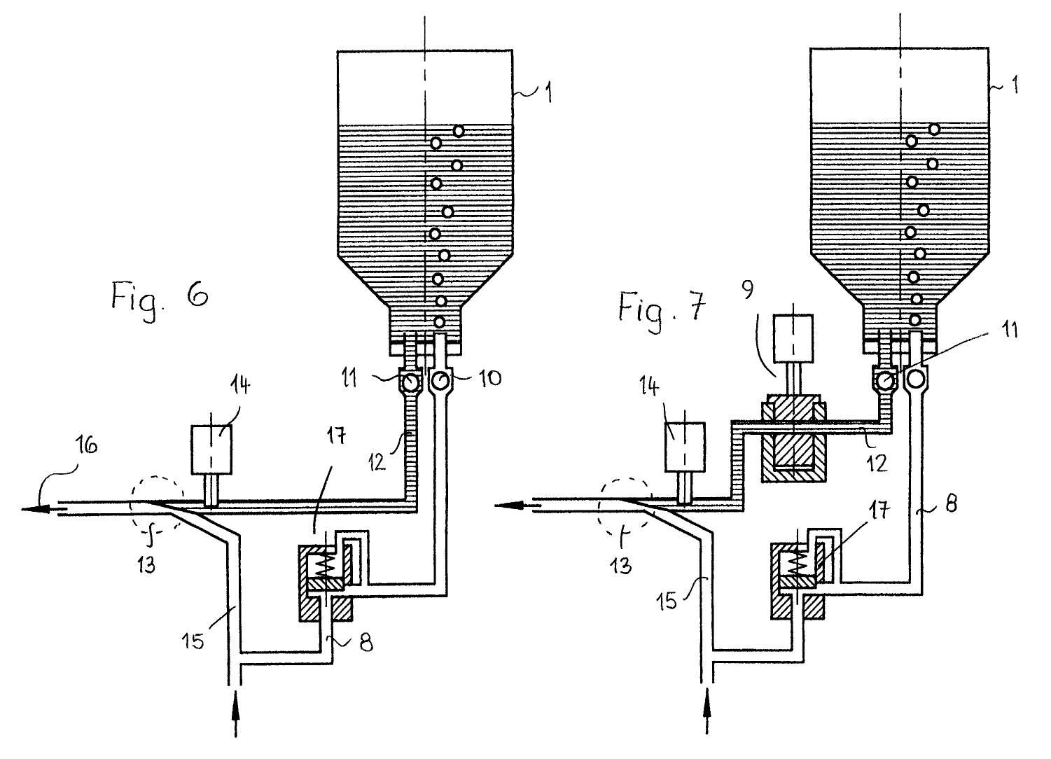

The embodiment according to FIG. 5 differs from the preceding embodiment only in that the metering device 14 is arranged directly behind the float valve 11 within the urea conveying conduit 12. Otherwise, this embodiment is identical to the embodiment of FIG. 4.

In the embodiment according to FIG. 6, the air supply conduit 8 is connected to the compressed air conduit 15 in the flow direction upstream of the metering device 14. A pressure reducing valve 17 is arranged in the air supply conduit 8. By means of the pressure reducing valve 17 the pressure of the compressed air is reduced such that the urea solution contained in the container 1 is pressurized by the compressed air at reduced pressure. This ensures that the urea solution flows reliably via the float valve into the urea conveying conduit 12. In accordance with the configuration of FIG. 3, a float valve 10 is positioned in the air supply conduit 8 directly upstream of the container 1 and stays open as long as compressed air at reduced pressure is supplied.

In the urea conveying conduit 12 the metering device 14 is positioned with which the urea solution is supplied in the desired amount to the mixing area 13 where it is mixed with the compressed air supplied by means of the compressed air conduit 15 to form a mist. This mist is then supplied in the flow direction 16 to the catalytic converter.

In the embodiment according to FIG. 7, the on-off valve 9 for closing the urea conveying conduit 12 is seated in the urea conveying conduit 12 in the area between the metering device 14 and the float valve 11. In this embodiment the compressed air also flows via the compressed air conduit 15 into the mixing area 13 in which it is mixed with the urea solution supplied via the urea conveying conduit 12. The compressed air flows more over via the pressure reducing valve 17 into the air supply conduit 8 in which the pressure-reduced compressed air flows into the container 1.

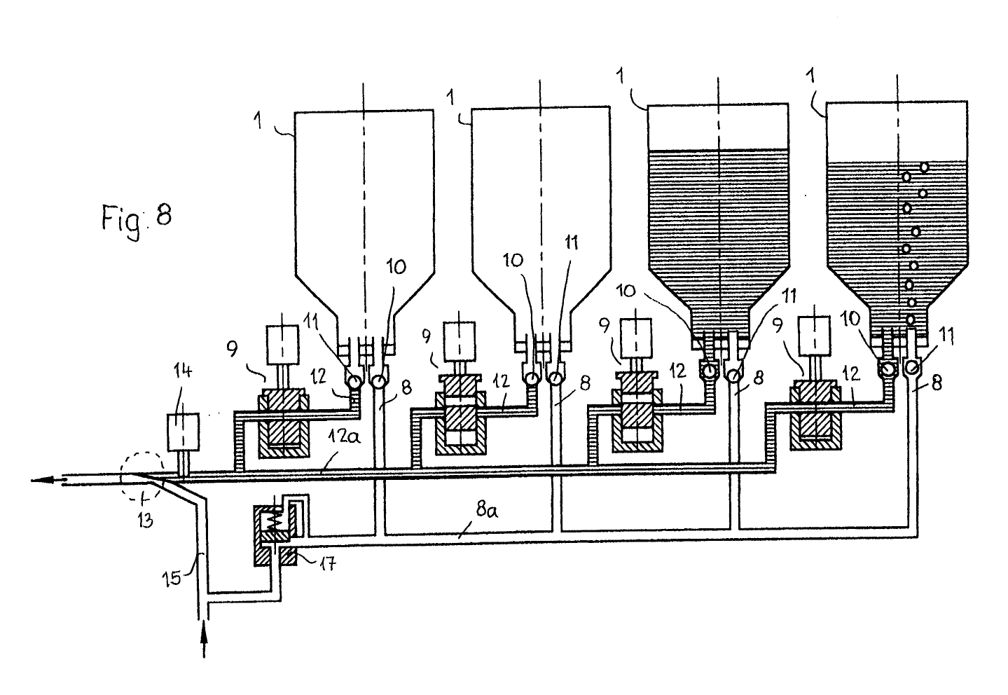

In the embodiment according to FIG. 8 several containers 1 are arranged adjacent to one another. Each container 1 is placed onto an urea conveying conduit 12 and an air supply conduit 8, respectively. Each urea conveying conduit 12 is provided with an on-off valve 9 in order to shut off or open the containers 1 as needed. The urea conveying conduits 12 open into a common urea conveying main 12a. The metering device 14 is seated directly upstream of the mixing area 13 in the common urea conveying main 12a. The air supply conduits 8 are also connected to a common air supply main 8a in which the pressure reducing valve 17 is positioned. The common air supply main 8a opens into the compressed air conduit 15 via which the compressed air reaches the mixing area 13. In the mixing area 13, the compressed air is mixed with the urea solution to form a mist, as described above. A portion of the compressed air flows via the pressure reducing valve 17 into the common air supply main 8a and from there via the individual air supply conduits 8 into the containers 1, respectively.

In the illustrated embodiment, the left and right on-off valves 9 are open so that a connection between the common urea conveying main 12a and these two storage containers 1 is provided. The two centrally arranged on-off valves 9 are closed. As long as the urea solution flows into the air supply conduits 8 and the compressed air flows via the air supply conduits 8 into the respective container 1, the float valves 10, 11 are opened.

As already described in connection with the embodiment of FIG. 3, the container 1 can be switched on and off as desired by means of the on-off valves 9 so that an optimal mixture formation is ensured. In the simplest embodiment, the on-off valves 9 are manually actuated. However, it is advantageous when the on-off valves 9 are automatically opened and closed by means of a control unit.

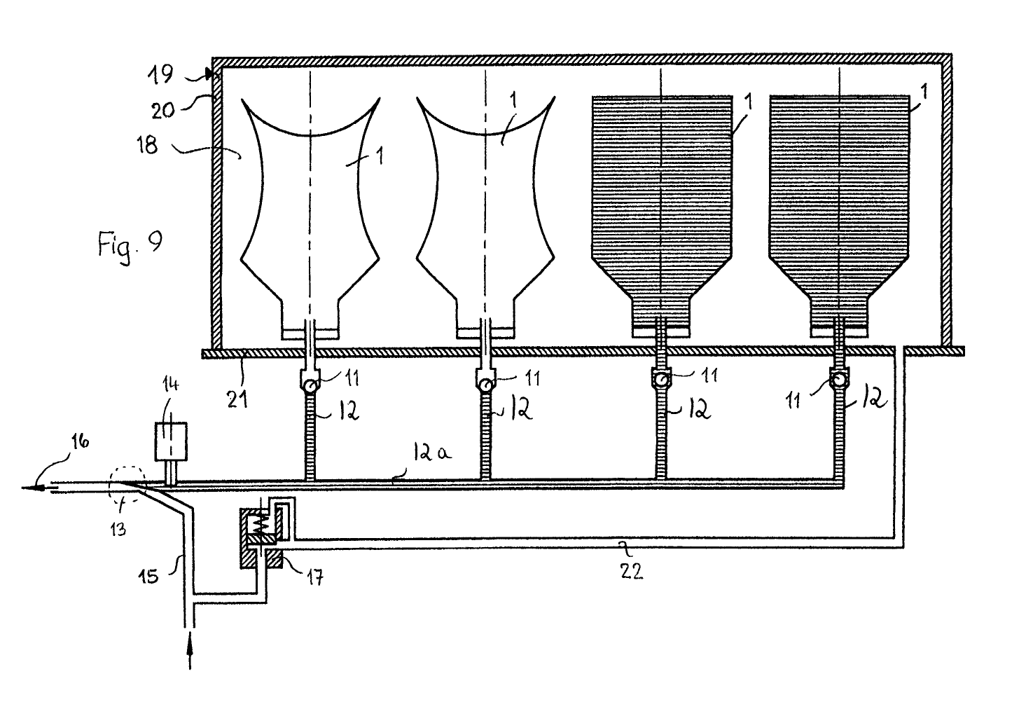

FIG. 9 shows an embodiment in which the containers 1 are arranged in a chamber 18. The chamber 18 is enclosed by a housing 19 which has a removable lid 20. In the shown embodiment, the lid 20 is hood-shaped and can be simply removed from the base plate 21 of the housing 19 for exchanging or replacing the container 1. Of course, the housing 19 can have any suitable shape. It is only important that a removable housing part is provided which, on the one hand, can be removed easily for exchanging or replacing the container 1 and, on the other hand, can close off the chamber 18 in an airtight way when in the closed position.

At least one compressed air conduit 22 opens into the chamber 18 and is connected to the compressed air conduit 15. The pressure reducing valve 17 is positioned in the compressed air conduit 22. Moreover, the ends of the urea conveying conduits 12 open into the chambers 18, respectively, and the containers 1 within the chamber 18 are placed onto these ends, respectively. The urea conveying conduits 12 are connected to a common urea conveying main 12a in which the metering device 14 is seated directly before the mixing area 13. Directly upstream of the chamber 18 the float valves 11 are positioned in the urea conveying conduits 12, respectively.

The container 1 in the chamber 18 are flexible according to the embodiment of FIG. 1. In order for the urea solution to flow reliably out of these flexible containers 1 via the urea conveying conduits 12 into the mixing area 13, compressed air is supplied via the pressure reducing valves 17 and the compressed air conduit 22 into the chamber 18. Accordingly, the flexible containers 1 within the chamber 18 are externally loaded by pressure so that the urea solution can reliably flow into the urea conveying conduits 12. The pressure reducing valve 17 ensures, as in the embodiments according to FIGS. 6 through 8, that the urea solution flows with the predetermined pressure into the urea conveying conduits 12. The pressure reducing valve 17 in the corresponding embodiments can be adjusted to a predetermined pressure value. However, it is also possible to configure the pressure reducing valve 17 so as to be adjustable so that, depending on the requirements, different pressures can be adjusted for supplying the compressed air via the conduit 22 into the chamber 18.

In the illustrated embodiment the two containers to the left are already empty so that they are contracted to a large degree. The float valves 11 close the urea conveying conduits 12 because urea solution no longer flows therein. The two containers 1 to the right are still filled with urea solution. The corresponding float valves 11 in the individual urea conveying conduits 12 are open so that the urea solution from the container 1, assisted by the pressure present within the chamber 18, can flow reliably into the urea conveying conduits 12. In the mixing area 13 downstream of the metering device 14 the urea solution is mixed in the described way with the compressed air. The resulting mist is then supplied in the flow direction 16 to the catalytic converter.

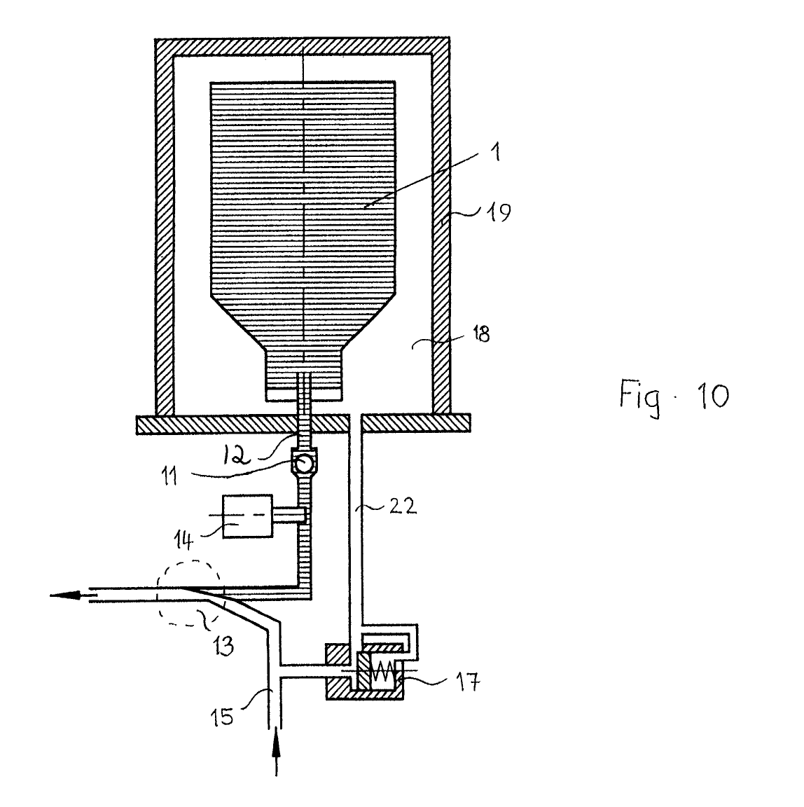

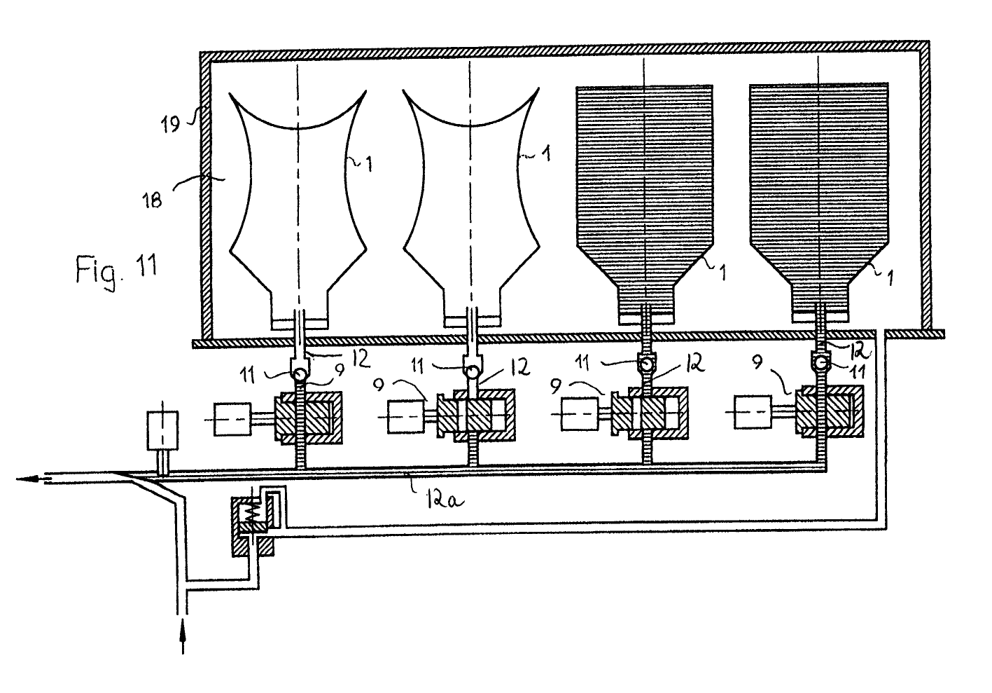

FIG. 10 shows in comparison to the embodiment of FIG. 9 a simplified embodiment in which a housing 19 contains only a single container 1. It is placed onto the urea conveying conduits 12 projecting into the chamber 18. Directly downstream of the float valves 11 the metering device 14 is arranged in the urea conveying conduit 12 with which the flow volume of the urea solution can be adjusted precisely. The metering device 14 can be embodied such that the flow volume can be adjusted manually. Advantageously, the metering device 14 is however adjusted by means of a control device so that the required amount of urea solution can be supplied optimally to the mixing area 13.

The compressed air conduit 22 opens into the chamber 18 and is connected to the compressed air conduit 15. The pressure reducing valve 17 is arranged in the conduit 22. The compressed air supply of the vehicle provides the compressed air which flows via the compressed air conduit 15 at the pressure provided by the compressed air supply into the mixing area 13 where it is mixed with the supplied urea solution in the way described above. A portion of the compressed air flows via the branched-off compressed air conduit 22 through the pressure reducing valve 17 which reduces the pressure of the compressed air to a predetermined value before it enters the chamber 18. The container 1 is again of a flexible configuration and is loaded externally by the compressed air within the chamber 18. Accordingly, the urea solution, assisted by this external pressure, can flow reliably via the urea conveying conduit 12 to the mixing area 13.

The embodiment according to FIG. 11 is substantially of the same configuration as the embodiment of FIG. 9. The difference resides only in that an on-off valve 9 is arranged, respectively, in the individual urea conveying conduits 12 in the area between the float valve 11 and the opening into the common urea conveying main 12a. Accordingly, each container 1 in the chamber 18 of the housing 19 can be switched on or off as needed. In other respects, this device operates identically to the embodiment of FIG. 9.

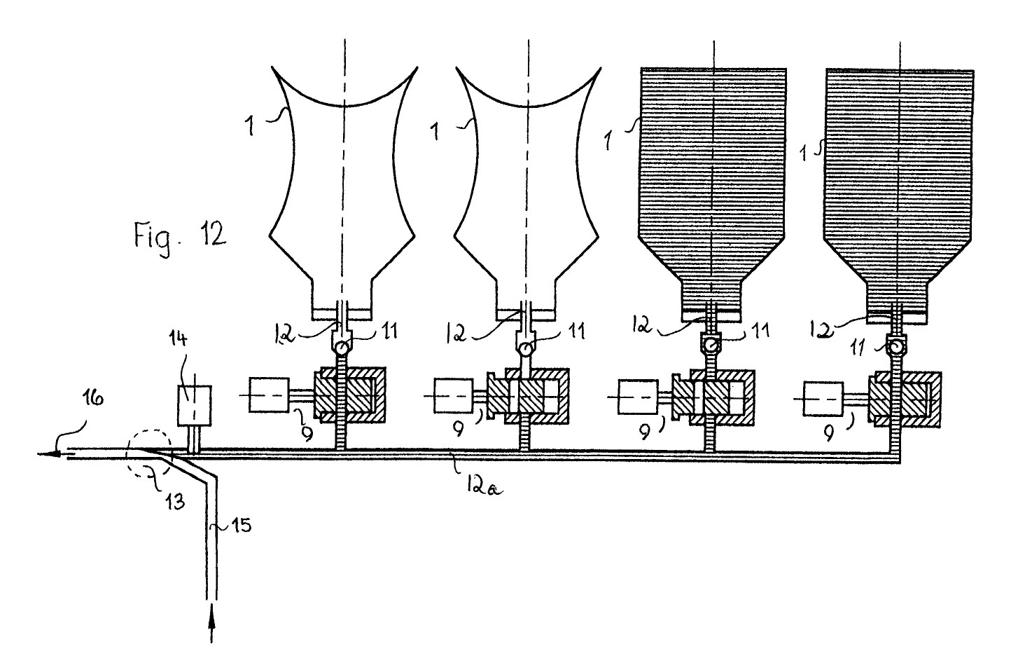

FIG. 12 shows a device in which the urea solution is contained in a flexible container 1. The two left containers 1 in FIG. 12 are empty, while the two right containers 1 are filled. The flexible containers 1 are placed as described above, respectively, onto the free end of the urea conveying conduits 12 which are connected to a common urea conveying main 12a. In the area between the float valve 11 and the opening into the common urea conveying main 12a, each of the individual urea conveying conduits 12 has arranged therein an on-off valve 9 with which each container 1 can be switched on or off, as needed. The urea solution flows, assisted by atmospheric pressure, via the open on-off valve 9 into the common urea conveying main 12a.

Directly upstream of the mixing area 13, the metering device 14 is arranged in the common urea conveying main 12a with which the amount of urea solution to be supplied can be precisely adjusted. The compressed air conduit 15 opens in the mixing area 13, and the compressed air of the compressed air supply system of the vehicle is supplied by it to the mixing area 13. By employing the venturi effect, mixing of the compressed air with the urea solution takes place in the mixing area 13. The resulting mist is supplied in the flow direction 16 to the catalytic converter.

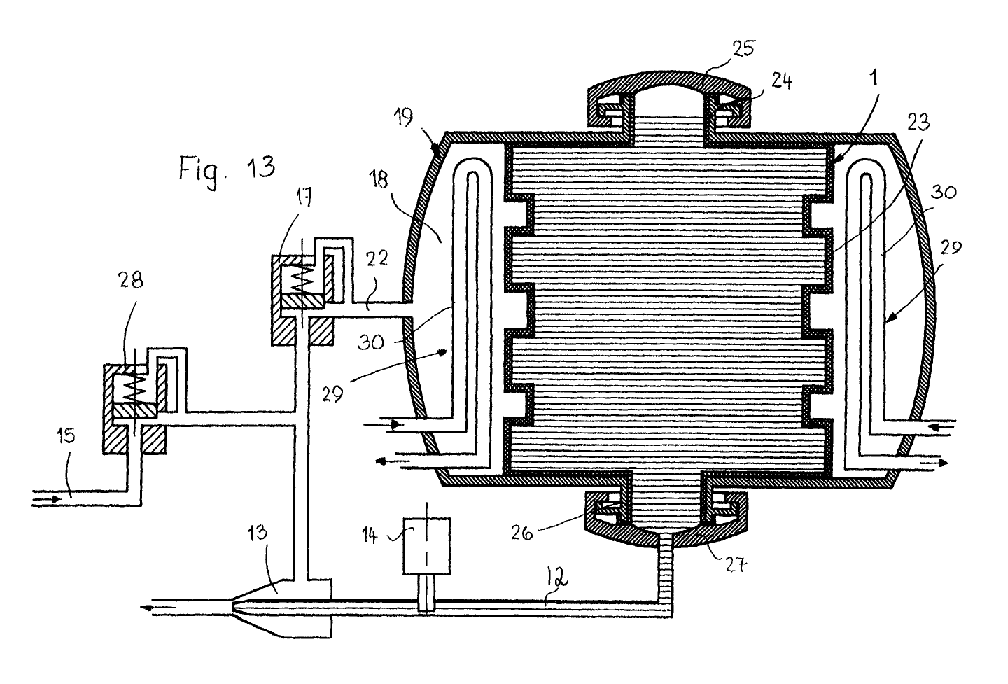

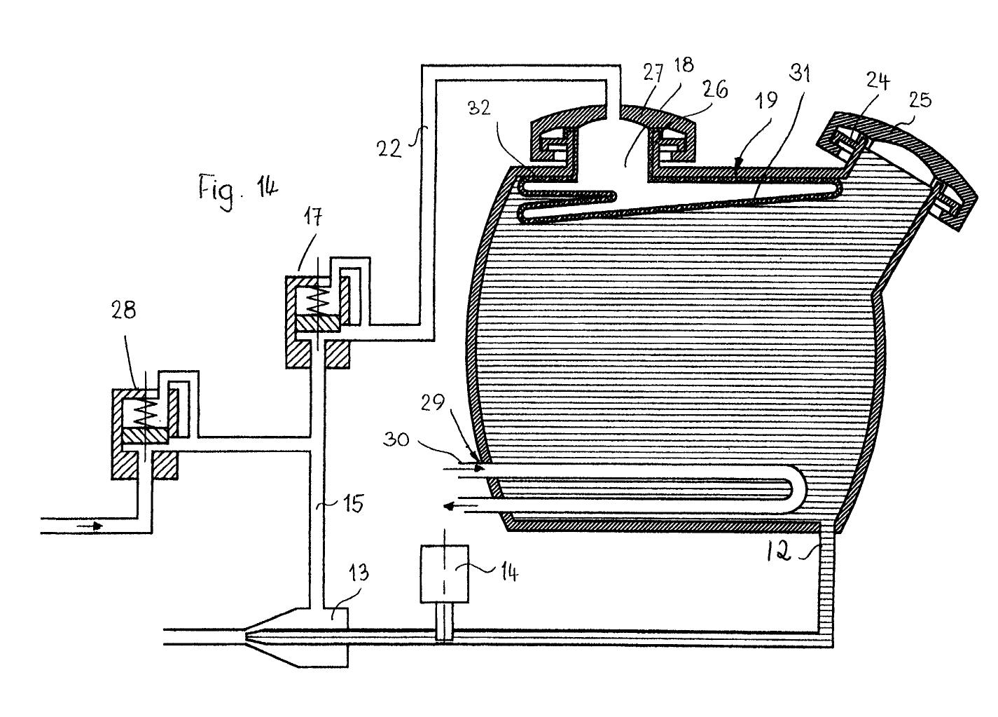

FIG. 13 shows a container which is arranged in the pressure chamber 18 of the housing 19. The wall 23 of the container 1 is a membrane comprised of an elastically stretchable material.

The housing 19 has a fill socket 24 which is closed off by a lid 25. On the housing 19 an outlet socket 26 is provided onto which a closure 27 can be placed. The urea conveying conduit 12 is connected to the closure via which the urea solution contained in the container 1 can flow into the mixing area 13. The metering device 14 is positioned in the area between the outlet socket 26 and the mixing area 13.

The mantle 23 of the container 1 is configured such that it rests against the inner wall of the sockets 24, 26 and engages their free end. The lid 25 and the closure 27 are configured such that they rest with interposition of the container mantle 23 on the end face of the respective socket 24, 26.

The compressed air conduit 22 opens into one end face of the housing 19 via which compressed air of reduced pressure is conveyed into the chamber 18. The compressed air is taken from the compressed air supply system of the vehicle and flows first into the compressed air conduit 15. In the compressed air conduit 15 a pressure reducing valve 28 is positioned with which the pressure of the compressed air is reduced to the required value. A portion of this compressed air flows subsequently to the mixing chamber 13 while another portion flows via the pressure reducing valve 17 and the compressed air conduit 22 into the chamber 18. Since the compressed air flows through two pressure reducing valves 17, 28 before entering the chamber 18, the compressed air entering the chamber 18 has a lower pressure value than the compressed air flowing into the mixing area 13.

The urea solution contained in the container 1, assisted by the pressure in the chamber 18, flows through the urea conveying conduit 12 into the mixing area 13. As a result of the pressure loading of the flexible mantle 23 of the container 1 by compressed air, the mantle 23 is compressed so that the urea solution is reliably forced into the urea conveying conduit 12. The mantle 23 is comprised advantageously of an elastomeric material such as rubber.

In the area between the container 1 and the wall of the housing 19 a heating device 29 is arranged which is actuated when the exterior (ambient) temperatures are so low that the urea solution would solidify. The heating can be realized electrically or by means of a heating medium. In the illustrated embodiment heating pipes 30 are provided through which a heating medium flows in the direction of the illustrated flow arrows. In the illustrated embodiment, a heating device 29 is provided on the two oppositely arranged sides of the container 1, respectively, so that an optimal heating of the urea solution at low exterior temperatures is ensured.

The lid 25 and the closure 27 on the sockets 24, 26 are pressure-resistant. The lid 25 can be easily removed from the fill socket 24 in order to refill urea solution into an empty container 1. Since the mantle 23 engages the end faces of the two sockets 24, 26 and the lid 25 and closure 27 are seated thereon in the closed position, respectively, the two sockets 24, 26 are sealed by this part of the flexible mantle 23.

FIG. 14 shows an embodiment in which the container 19 is provided with the fill socket 24 and the outlet socket 26. In contrast to the preceding embodiment, these two sockets 24, 26 are not provided on oppositely positioned sides of the housing 19 but on the same side of the housing. Both sockets are closed off by the lid 25 and the closure 27. A pressure membrane 31 adjoins the outlet socket 26. It rests against the inner wall of the outlet socket 26 and extends across its end face to the exterior. In correspondence with the preceding embodiment, the pressure membrane 31 is connected on the inner wall of the outlet socket 26 in a suitable way, for example, by an adhesive. A portion of the pressure membrane 31 is fastened to the inner side 32 of the housing wall adjoining the outlet socket 26. The remaining part of the pressure membrane 31 is advantageously folded multiple times when the housing 19 is filled. The pressure membrane 31 delimits the pressure chamber 18 into which compressed air is supplied via the compressed air conduit 22. As a result of the presence of this compressed air, the pressure membrane 31 will expand so that the urea solution within the housing 19 is pressurized. The urea solution thus flows reliably into the urea conveying conduit 12 at the opposite side of the housing 19. The pressure membrane 31 is configured such that the urea solution can be forced completely out of the housing 19.

The metering device 14 is positioned in the urea conveying conduit 12 directly upstream of the mixing area 13. The compressed air conduit 15 opens into the mixing area 13 and supplies the compressed air from the compressed air supply system of the vehicle. A pressure reducing valve 28 is arranged in the compressed air conduit 15 with which the pressure of the compressed air is reduced to the desired value. A portion of this compressed air flows in the described way into the mixing area 13. Another portion of the compressed air flows via the pressure reducing valve 19 into the compressed air conduit 22 which supplies this compressed air at reduced pressure into the chamber 18.

In contrast to the previous embodiment, the heating device 29 projects directly into the urea solution within the housing 19. When the ambient temperature is low, the heating device 29 is switched on in order to prevent the urea solution from freezing. According to the preceding embodiment, the heating device can be electrically operated. Advantageously, the heating pipe 30 of the heating device 29 contains a heating medium taken from the heating and cooling system of the vehicle and circulates it.

While specific embodiments of the invention have been shown and described in detail to illustrate the inventive principles, it will be understood that the invention may be embodied otherwise without departing from such principles.

What is claimed is:

1. A device for exhaust gas after treatment of diesel engines, the device comprising:
one or more storage containers (1) configured to contain an urea solution and having a flexible wall;
a mixing area (13);
at least one compressed air conduit (15) connected to the mixing area (13) and configured to supply compressed air to the mixing area (13);
a pump (4) configured to convey the urea solution from the one or more storage containers (1) to the mixing area (13);
wherein the mixing area (13) is configured to form a mist of the urea solution and the compressed air.

2. The device according to claim 1, wherein the storage container (1) has a closure (5) having at least one first connector (2) and wherein the pump (4) comprises a pump line (3) connected to the at least one connector (2).

3. The device according to claim 2, wherein the at least one connector is a plug-in opening.

4. The device according to claim 2, wherein the closure (5) has a second connector (7) configured to receive an air supply conduit (8).

5. The device according to claim 4, wherein the second connector (7) is a plug-in opening.

6. The device according to claim 4, wherein the first and second connectors (2, 7) comprise a closure element.

7. The device according to claim 6, wherein the closure element is opened when placing the storage container (1) onto the pump line (3) or the air supply conduit (8), respectively.

8. A device for exhaust gas after treatment of diesel engines, the device comprising:
at least one storage container (1) configured to contain an urea solution;
a mixing area (13);
at least one compressed air conduit (15) connected to the mixing area (13) and configured to supply compressed air to the mixing area (13);
a pump (4) having at least one pump line (3) configured to convey the urea solution from the storage container (1) to the mixing area (13);
wherein the mixing area (13) is configured to form a mist of the urea solution and the compressed air;
wherein the at least one storage container (1) is configured to be plugged onto the at least one pump line (3).

9. The device according to claim 8, wherein the at least one pump line (3) comprises an on-off valve (9).

10. The device according to claim 8, wherein the at least one pump line (3) comprises a float valve (11).

11. The device according to claim 8, further comprising at least one air supply conduit (8) configured to supply air to the at least one storage container (1), wherein the at least one storage container (1) is configured to be plugged onto the at least one air supply conduit (8).

12. The device according to claim 11, wherein the at least one air supply conduit (8) comprises a float valve (10).

13. The device according to claim 11, wherein each one of the storage containers (1) is plugged onto one of the pump lines (3) and one of the air supply conduits (8).

14. The device according to claim 13, wherein the pump (4) has a common pump main (3a) and wherein the pump lines (3) are connected to the common pump main (3a).

15. The device according to claim 13, further comprising an air supply main (8a) wherein the air supply conduits (8) are connected to the air supply main (8a).

16. The device according to claim 13, wherein each one of the pump lines (3) comprises an on-off valve (9).

17. The device according to claim 13, wherein each one of the pump lines (3) comprises a float valve (11).

18. The device according to claim 13, wherein each one of the air supply conduits (8) comprises a float valve (10).

19. A device for exhaust gas after treatment of diesel engines, the device comprising:
one or more storage containers (1) configured to contain an urea solution;
a mixing area (13);
at least one compressed air conduit (15) connected to the mixing area (13) and configured to supply compressed air to the mixing area (13);
at least one urea conveying conduit (12) configured to convey the urea solution under the own weight of the urea solution from the one or more storage containers (1) to the mixing area (13);
wherein the mixing area (13) is configured to form a mist of the urea solution and the compressed air.

20. The device according to claim 19, wherein the urea conveying conduit (12) comprises afloat valve (11).

21. The device according to claim 19, comprising a metering device (14) configured to control a flow volume of the urea solution flowing through the urea conveying conduit (12).

22. The device according to claim 19, comprising at least one air supply conduit (8) connected to the at least one storage container (1).

23. The device according to claim 22, wherein the air supply conduit (8) comprises a float valve (10).

24. The device according to claim 22, wherein the air supply conduit (8) branches off the compressed air conduit (15).

25. The device according to claim 24, wherein the air supply conduit (8) comprises a pressure reducing valve (17).

26. The device according to claim 19, wherein the urea conveying conduit (12) comprises an on-off valve (9) for shutting off flow of the urea solution through the urea conveying conduit (12).

27. The device according to claim 19, further comprising a conveying main (12a) connected to the mixing area, wherein the urea conveying conduits (12) of the storage containers (1) are parallel connected to the conveying main (12a).

28. The device according to claim 27, further comprising a common air supply main (8a) connected to the storage containers (1).

29. The device according to claim 28, wherein the common air supply main (8a) comprises a pressure reducing valve (17).

30. The device according to claim 28, wherein the common air supply main (8a) branches off the compressed air conduit (15).

31. The device according to claim 27, wherein the urea conveying conduits (12) comprise an on-off valve (9), respectively.

32. A device for exhaust gas after treatment of diesel engines, the device comprising:
one or more storage containers (1) configured to contain an urea solution;
a mixing area (13);
at least one compressed air conduit (15) connected to the mixing area (13) and configured to supply compressed air to the mixing area (13);
at least one urea conveying conduit (12) configured to convey the urea solution from the one or more storage containers (1) to the mixing area (13);
wherein the mixing area (13) is configured to form a mist of the urea solution and the compressed air;
a pressure chamber (18) configured to receive the one or more storage containers (1);
at least one compressed air supply conduit (22) connected to the pressure chamber (18).

33. The device according to claim 32, wherein the at least one compressed air supply conduit (22) comprises a pressure reducing valve (17).

34. The device according to claim 32, wherein the compressed air supply conduit (22) branches off the compressed air conduit (15).

35. The device according to claim 32, wherein the storage container has a flexible wall.

36. The device according to claim 32, wherein the storage container (1) is configured to be plugged onto the urea conveying conduit (12).

37. The device according to claim 32, wherein the urea conveying conduit (12) comprises a float valve (11).

38. The device according to claim 32, comprising at least one metering device (14) configured to control a flow volume of the urea solution flowing through the urea conveying conduit (12).

39. The device according to claim 32, further comprising an urea conveying main connected to the mixing area, wherein the urea conveying conduits (12) of the storage containers (1) received in the pressure chamber (18) are parallel connected to the urea conveying main (12a).

40. The device according to claim 39, wherein the urea conveying conduits (12) comprise an on-off valve (9), respectively.

41. A device for exhaust gas after treatment of diesel engines, the device comprising:
one or more storage containers (1) configured to contain an urea solution;
a mixing area (13);
at least one compressed air conduit (15) connected to the mixing area (13) and configured to supply compressed air to the mixing area (13);
at least one urea conveying conduit (12) configured to convey the urea solution from the one or more storage containers (1) to the mixing area (13);
wherein the mixing area (13) is configured to form a mist of the urea solution and the compressed air;
wherein the storage container (1) has a wall (23, 31) at least partially formed by a flexible pressure membrane.

42. The device according to claim 41, comprising a housing (19) wherein the storage container (1) is arranged in the housing (19).

43. The device according to claim 42, wherein the housing (19) has at least one fill socket (24).

44. The device according to claim 42, wherein the housing has at least one outlet socket (26).

45. The device according to claim 41, wherein the pressure membrane (23, 21) is configured to be elastically deformable by pressure loading.

46. The device according to claim 41, wherein the housing (19) comprises at least one compressed air supply conduit (22).

47. The device according to claim 46, wherein the compressed air supply conduit (22) comprises a pressure reducing valve (17).

48. The device according to claim 42, wherein the housing (19) has at least one heating device (29).

49. The device according to claim 48, wherein the heating device (29) projects into the urea solution.

50. The device according to claim 42, wherein the pressure membrane (31) is a folded bellows.
